(19) United States
(12) Patent Application Publication
(10) Pub. No.: US 2006/0144637 A1
(43) Pub. Date: Jul. 6, 2006

(54) Sound-attenuating enclosure with integral cooling ducts

(75) Inventors: Charles Swartz, Mocksville, NC (US); William Roger Hutchinson, Clemmons, NC (US); David Franklin Rowe JR., Mocksville, NC (US); Randy Rhoades, Booneville, IN (US)

Correspondence Address: Michael Best & Friedrich LLP, Suite 3300, 100 East Wisconsin Avenue, Milwaukee, WI, 53202-4108, US

(73) Assignee: Ingersoll-Rand Company, Montvale, NJ (US)

(21) Appl. No.: 11/312,255

(22) Filed: Dec. 20, 2005

Related U.S. Application Data
(60) Provisional application No. 60/638,531, filed on Dec. 23, 2004.

(51) Int. Cl. H02K 5/24

(52) U.S. Cl. 181/198; 181/202; 296/187.01

(57) ABSTRACT

A sound-attenuating enclosure for a portable machine. The enclosure includes an inner shell, an outer shell, and a duct. The inner shell includes an inner air inlet opening, and the outer shell includes an outer air inlet opening. The duct connects the outer air inlet opening and the inner air inlet opening, while preventing a line-of-sight between the outer air inlet opening and the inner air inlet opening.

### RELATED APPLICATIONS

This application claims priority to U.S. Provisional Patent Application No. 60/638,531, filed on Dec. 23, 2004, titled “Sound Attenuating Enclosure with Integral Cooling Ducts”, the entire content of which is incorporated herein by reference.

### FIELD OF THE INVENTION

The invention relates to machine enclosures. More particularly, the invention relates to a sound-attenuating enclosure including cooling air ducts.

### BACKGROUND

Machinery, such as portable compressors and generators, often produce relatively high levels of noise during operation. Enclosures have been fitted around such machinery to reduce the emitted noise. However, the enclosures generally restrict the flow of cooling air, which is necessary to avoid overheating. Openings have been added to the enclosures allowing cooling air to enter the enclosure, but the openings also permit noise to escape.

Internal baffles have been used to reduce the amount of noise escaping through the openings, but these baffles increase the cost of the enclosure. Additionally, enclosures with extensive baffles at the inlets usually cause a reduction in airflow or a redirection of cooling air away from critical areas that must remain cool.

### SUMMARY

In one embodiment, the invention provides a sound-attenuating enclosure for enclosing a portable machine. The sound-attenuating enclosure includes an inner shell having an inner air inlet opening, an outer shell having an outer air inlet opening, and a duct passage between the inner shell and the outer shell connecting the inner air inlet opening and the outer air inlet opening. The inner shell is positioned within the outer shell to form a space between the inner shell and the outer shell. The outer air inlet opening is offset from the inner air inlet opening to prevent a line-of-sight between the outer air inlet opening and the inner air inlet opening.

In another embodiment, the invention provides a portable machine assembly including a towing structure having at least one towing bar and at least one wheel, a base coupled to the towing structure, an inner shell having an inner air inlet opening, and an outer shell having an outer air inlet opening offset from the inner air inlet opening to prevent a line-of-sight between the outer air inlet opening and the inner air inlet opening. The inner shell is positioned inside the outer shell to form a space between the outer shell and the inner shell to define a duct between the inner air inlet opening and the outer air inlet opening.

Other aspects of the invention will become apparent by consideration of the detailed description and accompanying drawings.

### BRIEF DESCRIPTION OF THE DRAWINGS

FIG. 1 is perspective view of a sound-attenuating enclosure coupled to a towing base.

FIG. 2 is an exploded side elevation view of inner and outer shells of the enclosure of FIG. 1.

FIG. 3 is a side elevation view of the enclosure of FIG. 1.

FIG. 4 is a cross-sectional view of the enclosure taken along line 4-4 of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

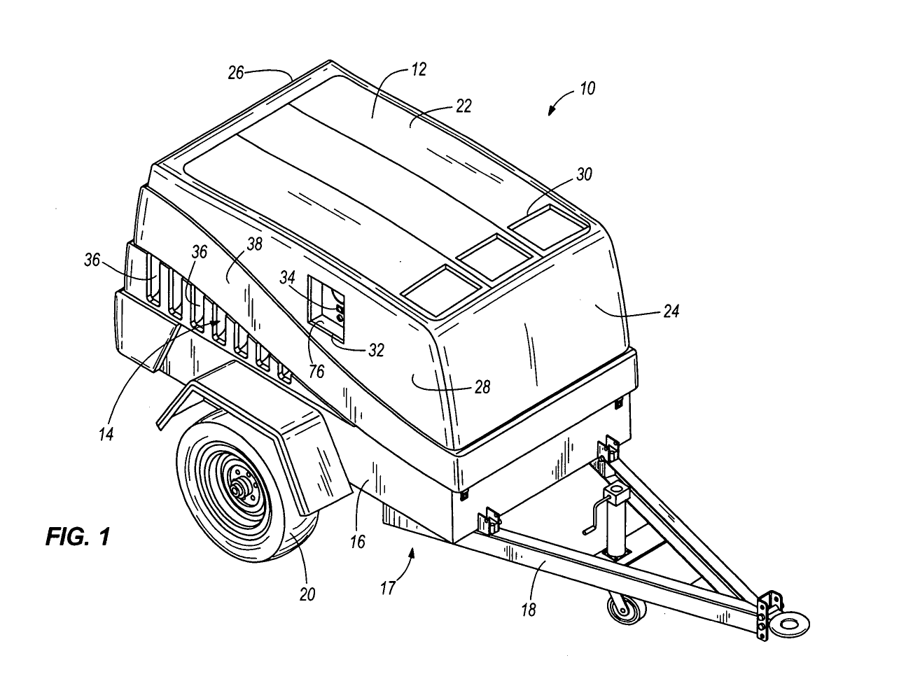

FIG. 1 illustrates a portable machine 10 including a sound-attenuating enclosure 12 having cooling ducts 14 and the enclosure 12 being releasably coupled to a base 16. In one embodiment, the base 16 has a substantially rectangular shape and can support various types of machinery or objects, such as internal combustion engines, air compressors, tool boxes, etc. The base 16 is mounted on a support structure 17 having a towable frame 18 and a set of wheels 20 releasably coupled to an axle (not shown). Other embodiments of the invention can include the sound-attenuating enclosure 12 and the base 16 supported by other support structures.

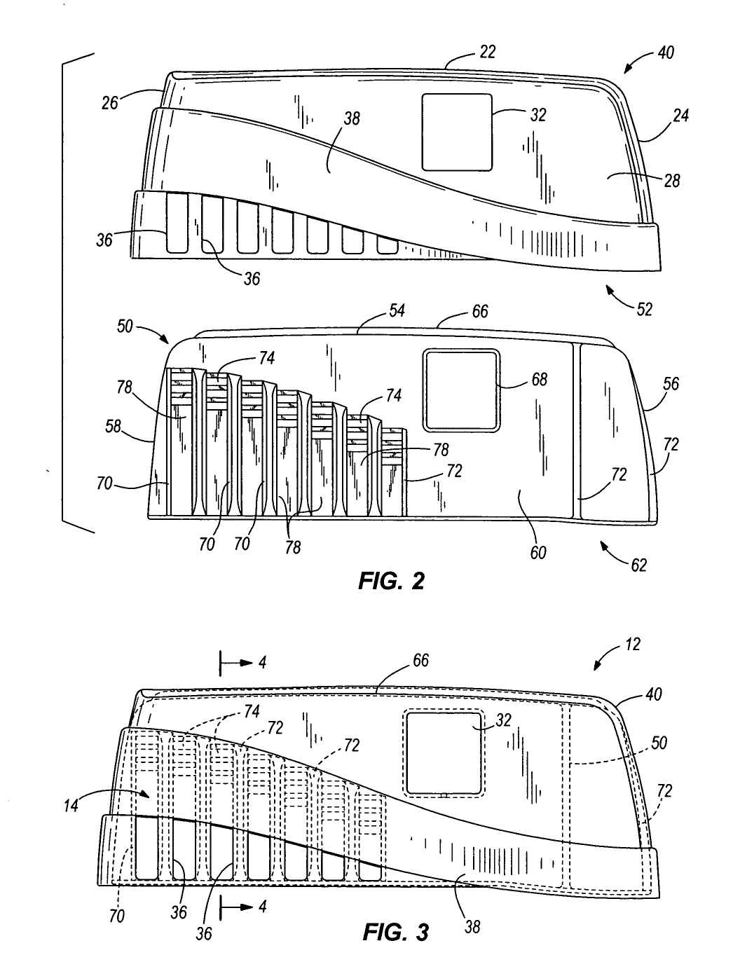

As shown in FIG. 2, the sound-attenuating enclosure 12 includes an outer shell 40 and an inner shell 50. FIGS. 1-2 illustrate that the outer shell 40 includes an upper wall 22, a front wall 24, a rear wall 26, and two side walls 28. In one embodiment, the upper wall 22 includes air exhaust openings 30 evenly spaced between the first and second side walls 28 and substantially adjacent to the front wall 24. One or more side walls 28 of the outer shell 40 include an instrument panel opening 32 having a substantially square shape, in one embodiment. The instrument panel opening can provide access to a control panel 34. In other embodiments, the instrument panel opening 32 can have different shapes or provide access to other portions of a portable machine supported by the base 16. In one embodiment, the side walls 28 also include air intake openings 36 substantially evenly spaced in the direction from the rear wall 26 to the front wall 24 of the outer shell 40. The air intake openings 36 extend in the direction from the base 16 to the upper wall 22 until reaching the lower edge of a duct wall 38.

The duct wall 38 projects outwardly from the surface of the outer shell 40 and is defined by the edges of the front, rear, and side walls 24, 26, 28. As shown in FIGS. 1-3, the duct wall 38 is closer to the upper wall 22 than the base 16 at the rear wall 26. From the rear wall 26, the duct wall 38 slopes toward the base 16 as the duct wall 38 approaches the front wall 24 of the outer shell 40. In other embodiments, the duct wall 38 can have other configurations, such as being spaced a uniform distance from the upper wall 22 along the duct wall's entire length or perimeter. The walls of the outer shell 40 form an enclosed space 52 to receive the inner shell 50.

As shown in FIG. 2, the inner shell 50 includes an upper wall 54, a front wall 56, a rear wall 58, and two side walls 60 to form an interior space 62. The upper wall 54 includes inner shell air exhaust outlets (not shown) at least partially forming the air exhaust openings 30 shown in FIG. 1. The upper wall 54 also includes upper wall projections 66 having rib-like structures. The upper wall projections 66 generally extend linearly between the front and rear walls 56, 58. One or more of the side walls 60 includes an inner shell instrument panel opening 68 partially of fully aligned with the outer shell instrument panel opening 32 to provide access to a control panel 34 of a compressor system or other machine supported by the base 16. As shown in FIG. 1, a sealing wall 76 extends from the edges of the inner shell instrument panel opening 68 to the outer shell instrument panel opening 32 of the sound-attenuating enclosure 12. The side walls 60 include ribs 70 projecting outwardly from the side walls 60 of the inner shell 50. The ribs 70 extend substantially vertically from the bottom of the inner shell 50 to various levels of the side walls 60 generally coinciding with the upper edge of the duct wall 38 when the inner shell 50 is positioned inside of the outer shell 40, as shown in FIG. 3.

In one embodiment, the ribs 70 projecting from the side walls 60 are substantially evenly spaced. As shown in FIGS. 2-3, the side walls 60 include inner shell air inlet openings 74 extending between the ribs 70 and being vertically aligned with the air intake openings 36. Wall sections 78 extend between the ribs 70 to at least partially form the cooling ducts 14. The air intake openings 36, the wall sections 78, the duct wall 38, and the inner shell air inlet openings 74 cooperate to form the cooling ducts 14 to allow cooling air into an interior space 62. As a result, the cooling ducts 14 do not include a line-of-sight between the interior space 62 and the air intake openings 36.

FIG. 3 illustrates the inner shell 50 (shown in dashed lines) coupled to the outer shell 40 (shown in solid lines) to define the sound-attenuating enclosure 12. The upper wall projections 66, the wall supports 72, and the ribs 70 defined by the inner shell 50 are raised to support the outer shell 40 at a distance from the inner shell 50. The space between the outer shell 40 and the inner shell 50 can help prevent vibration. In addition, the space between the outer shell 40 and the inner shell 50 helps dampen noise from the motor or compressor system. Moreover, the sealing wall 76 (as shown in FIG. 1) also helps to seal the space between the outer shell 40 and the inner shell 50 reducing the noise from the motor or compression system that escapes the enclosure 12.

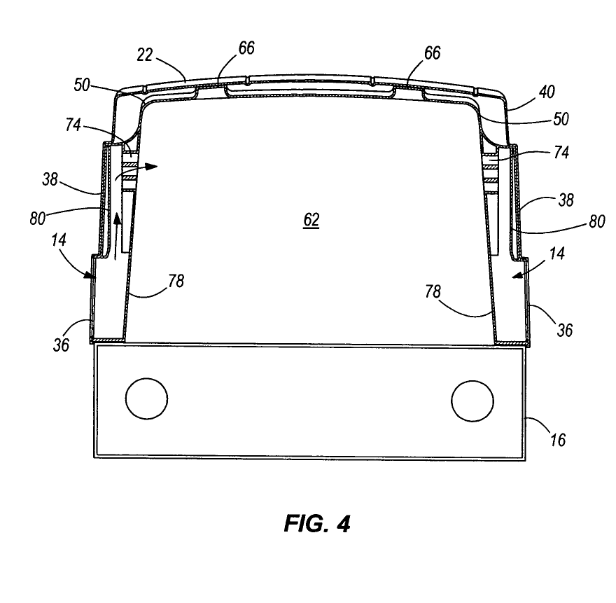

As shown in FIGS. 3-4, the ribs 70, the wall sections 78, and the duct wall 38 generally define the cooling ducts 14 extending from the air intake openings 36 to the inner shell air inlet openings 74. The cooling ducts 14 allow cooling air to flow into the interior space 62 and to minimize the sound exiting the sound-attenuating enclosure 12. In general, the sound-attenuating enclosure 12 is configured to allow cooling air to flow into the interior space 62 through the cooling ducts 14 and out of the interior space 62 through the air exhaust openings 30. However, cooling air can potentially flow into the interior space 62 through the air exhaust openings 30 and out of the interior space 62 through the cooling ducts 14.

In some embodiments, the outer shell 40 and the inner shell 50 are each formed as a molded part. However, the outer shell 40 and the inner shell 50 can also be manufactured with multiple components joined together. In some embodiments, sound absorbing material can be positioned in the space between the outer shell 40 and the inner shell 50. In some embodiments, the outer shell 40 can be manufactured with integral air pockets 80 (as shown in FIG. 4) to reduce the sound from by the motor or compressor system that exits the enclosure 12.

Various features and advantages of the invention are set forth in the following claims.

1. A sound-attenuating enclosure for enclosing a portable machine, the sound-attenuating enclosure comprising:
an inner shell having an inner air inlet opening;
an outer shell having an outer air inlet opening; and
a duct passage between the inner shell and the outer shell connecting the inner air inlet opening and the outer air inlet opening;
the inner shell positioned within the outer shell forming a space between the inner shell and the outer shell, the outer air inlet opening being offset from the inner air inlet opening to prevent a line-of-sight between the outer air inlet opening and the inner air inlet opening.

2. The sound-attenuating enclosure of claim 1, wherein an outer shell instrument panel opening and an inner shell instrument panel opening are aligned to provide access to a control panel.

3. The sound-attenuating enclosure of claim 1, wherein an inner shell exhaust opening at least partially defines an air exhaust opening.

4. The sound-attenuating enclosure of claim 1, wherein an acoustic absorbing material is positioned in the space between the outer shell and the inner shell.

5. The sound-attenuating enclosure of claim 1, wherein the inner shell includes a plurality of ribs.

6. The sound-attenuating enclosure of claim 1, wherein the outer shell includes at least one wall having an air pocket.

7. The sound-attenuating enclosure of claim 6, wherein the inner shell includes at least one wall having an air pocket.

8. The sound-attenuating enclosure of claim 3, wherein the duct includes a first air or gas flow traveling from the outer air inlet opening to the inner air inlet opening.

9. The sound-attenuating enclosure of claim 8, wherein the inner shell includes an enclosed space; and wherein the air exhaust opening includes a second air or gas flow escaping the enclosed space of the inner shell.

10. The sound-attenuating enclosure of claim 2, wherein the outer shell instrument panel opening and the inner shell instrument panel opening include a wall therebetween; and wherein the wall at least partially defines the space between the outer shell and the inner shell.

11. A portable machine assembly comprising:
a towing structure having at least one towing bar and at least one wheel;
a base coupled to the towing structure;
an inner shell having an inner air inlet opening; and
an outer shell having an outer air inlet opening offset from the inner air inlet opening to prevent a line-of-sight between the outer air inlet opening and the inner air inlet opening;
the inner shell positioned inside the outer shell forming a space between the outer shell and the inner shell to define a duct between the inner air inlet opening and the outer air inlet opening.

12. The portable machine assembly of claim 11, wherein an outer shell instrument panel opening and an inner shell instrument panel opening are at least partially aligned to provide access to a control panel.

13. The portable machine assembly of claim 11, wherein an inner shell exhaust opening at least partially defines an air exhaust opening.

14. The portable machine assembly of claim 11, wherein an acoustic absorbing material is positioned in the space between the outer shell and the inner shell.

15. The portable machine assembly of claim 11, wherein the inner shell includes a plurality of ribs.

16. The sound-attenuating enclosure of claim 11, wherein the outer shell includes at least one wall having an air pocket.

17. The sound-attenuating enclosure of claim 16, wherein the inner shell includes at least one wall having an air pocket.

18. The sound-attenuating enclosure of claim 13, wherein the duct includes a first air or gas flow traveling from the outer air inlet opening to the inner air inlet opening.

19. The sound-attenuating enclosure of claim 18, wherein the inner shell includes an enclosed space; and wherein the air exhaust opening includes a second air or gas flow escaping the enclosed space of the inner shell.

20. The sound-attenuating enclosure of claim 12, wherein the outer shell instrument panel opening and the inner shell instrument panel opening include a wall therebetween; and wherein the wall at least partially defines the space between the outer shell and the inner shell.
